(19) United States
(12) Patent Application Publication
(10) Pub. No.: US 2013/0297338 A1
(43) Pub. Date: Nov. 7, 2013

(54) Method for Evaluating the Health of a Website

(71) Applicant: INGROOVE, INC., Salt Lake City, UT (US)

(72) Inventor: Daniel Urmann, Salt Lake CIty, UT (US)

(73) Assignee: Ingroove, Inc., Salt Lake City, UT (US)

(21) Appl. No.: 13/888,235

(22) Filed: May 6, 2013

Related U.S. Application Data
(60) Provisional application No. 61/643,897, filed on May 7, 2012.

(51) Int. Cl. G06Q 30/00; G06Q 50/22

(52) U.S. Cl. CPC G06Q 30/018; G06Q 50/22
USPC 705/2

(57) ABSTRACT

The invention is a health indicator that is used to evaluate a website. The health indicator is used to evaluate performance and compare the website to predicted performance, similar websites, and websites of entities in adjacent industries. This health indicator will allow for a single view/metric, signified by a unique word, color, number, symbol or an identifiable marker, of the performance and of the Internet site as it relates to Search Engine Optimization, e-Commerce, Bounce Rates, Traffic Data, Traffic Flow, Conversion Rates, Page Views, Social and Mobile metrics, Shopping Cart Information, and any additional data the analysis system has access to.

An automated or manual triage assessment of the website provides administrators with recommendations on specific areas of possible improvements or a warning if certain areas (metrics) are outside of typical operating parameters. The automated triage system notifies an administrator on the occurrence of manually or automatically set events, such as when a parameter is outside of a specified range, and provide directions on how to solve the issue.

### CROSS REFERENCE

This application claims the benefit of provisional application Ser. No. 61/643897, filed on May 7, 2012, which is incorporated entirely herein by reference.

### BACKGROUND

Over the past few years, website analytics systems have been collecting data and permitting users to view statistical data related to those services. However, the viewer is left to apply their own analysis and interpretation to the data. The data presented is largely unhelpful to someone not versed in data interpretation and therefore does not provide any guidance on how it affects a website's overall security, accessibility and performance. The raw numerical data and lack of explanations make evaluating proposed and actual changes to a website extremely difficult. Therefore, there is a need for a simple way to understand the data and present information about the impact changes have on a website. In addition, there is need for a clear way to measure a website's online health.

### SUMMARY OF INVENTION

The invention is a health indicator for a website that evaluates past performance, predicts future performance, and compares the website to similar websites and those in adjacent industries. This health indicator gives administrators a single view/metric, signified by a unique word, color, number, symbol or an identifiable marker, of the performance and of the Internet site as it relates to Search Engine Optimization, e-Commerce, Bounce Rates, Traffic Data, Traffic Flow, Conversion Rates, Page Views, Shopping Cart Information, Social and Mobile metrics and any additional data the analysis system has access to.

The health indicator is based on aggregating website tracking data collected directly from a health metric system, through third parties and various other data and behavioral statistical reporting services. This collected data may then be, when necessary, normalized and validated for analysis. The resulting data is then combined and analyzed to produce one or more health indicators of the viability, performance and effectiveness of the internet site as it relates to past performance, predicted performance, and related industries, as well as adjacent industries of the analyzed website.

The invention also includes an automated or manual triage assessment of the Internet to indicate specific areas that can be improved and provide warnings when the website is no longer within standard operating parameters. The automated triage system can also provide direct assistance to an administrator on remediating issues by clearly identifying which change to the system resulted in the deviance from the set parameters.

### DESCRIPTION OF THE FIGURES

FIG. 1 is a flowchart showing one embodiment of the invention.

FIG. 2 is a depiction of the components used by the flowchart in FIG. 1.

FIG. 3 is a flowchart showing how a widget can display a health indicator.

FIG. 4 is an example widget.

FIG. 5 is an example dashboard.

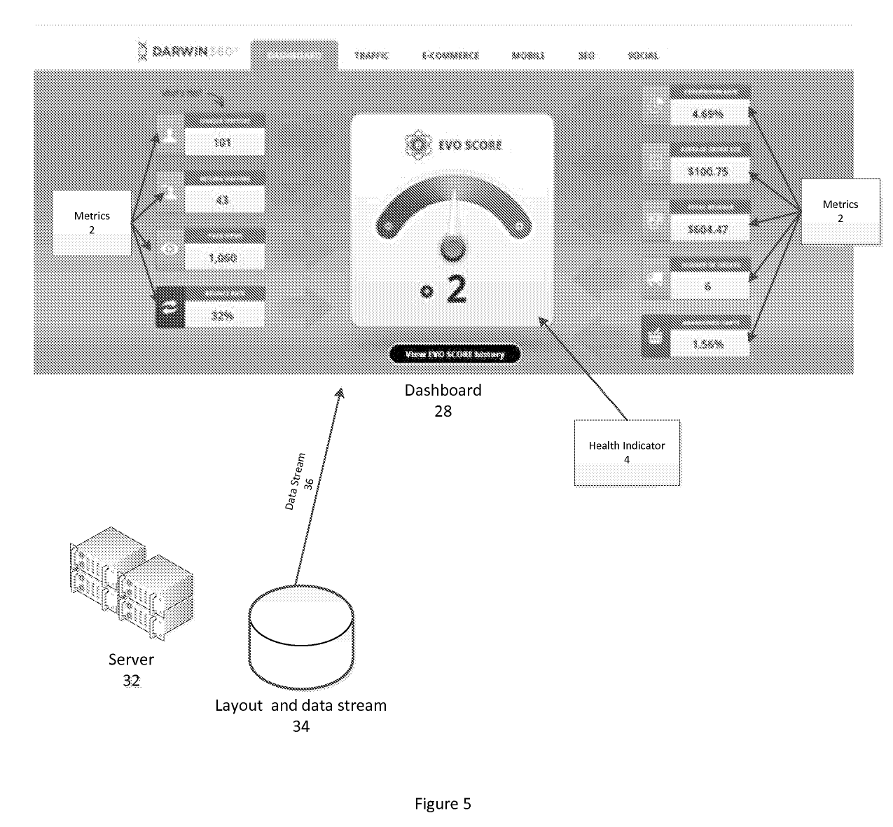

FIG. 6 is an embodiment of the invention that pulls data from multiple sources.

### DETAILED DESCRIPTION OF THE INVENTION

The invention discloses a method for evaluating a website and providing an indicator about the health of the website. The figures are for the purpose of illustrating the invention and preferred embodiment. However, the invention is not limited to the specific implementations shown in the figures as several of the steps and components are optional or intended only to increase security of the overall system.

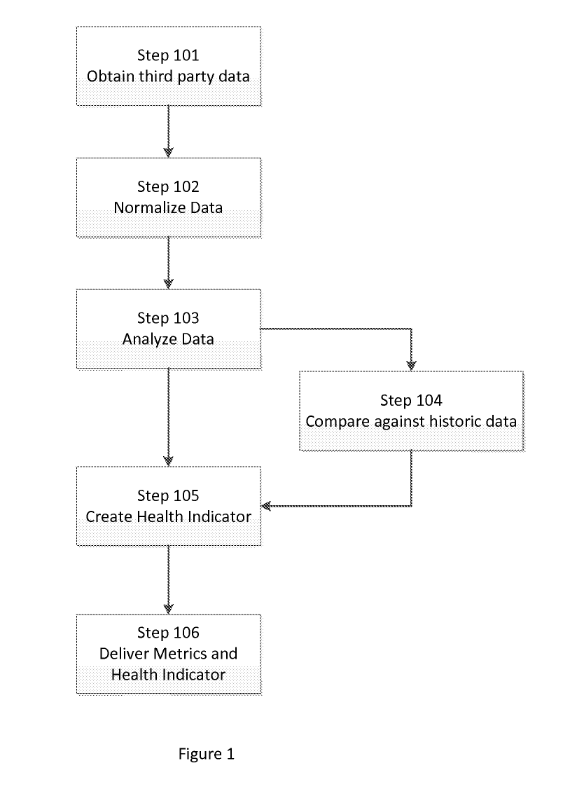

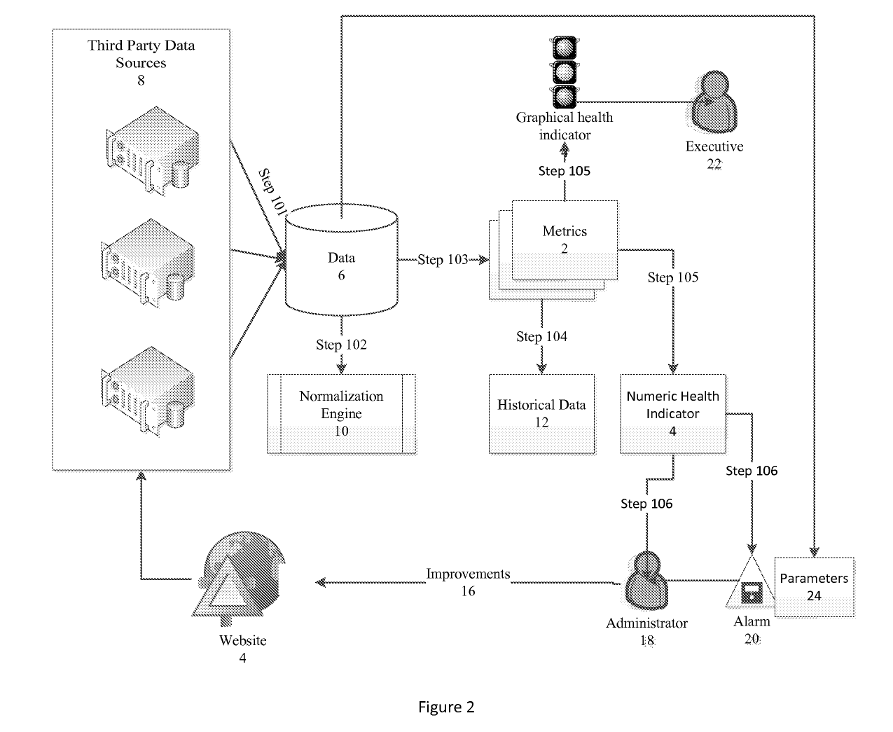

As shown in FIG. 1 and FIG. 2, the invention operates by creating metrics 2 about a website 4 (or group of websites) derived from aggregated statistical data 6 and/or other general Internet behavioral tacking systems, such as data obtained from third party sources 8, or by using a tracking code installed directly on the internet site being analyzed. In step 101, the date is aggregated from the sources and stored in an analysis system. The metrics used to evaluate a website are based on any data that the system is able to track and collect and the data can be checked as to whether or not it is within the established operating parameters either in real time or at set intervals depending on how often the data is received and updated by the system. Example metrics include unique traffic, conversion rates and bounce rates are all components that the system can gather data and track.

If desired, in step 102, the data is normalized using a normalization engine 10 and validated to remove outlier and invalid data. This step may include an automatic rectification of discrepancies and a manual review. In step 103, the data is analyzed to produce core metrics 2 and reporting data. In step 104, the metrics are compared against data previously gathered 12 (if available) to create a comparison of the website's current operation to how it should operate, such as past performance, predicted performance, related industries (other systems that share the same business model or product offering), adjacent industries (other systems that are related to the industry of the analyzed system), and general Internet behavior (the overall industry trends of users using or accessing the category of service being analyzed). The comparisons may be set manually by the user or automatically be set by the system. The older data can be obtained through the third party sources.

In step 105, one or more health indicators 4 are created based on the analyzed statistics, including a single display representing the performance of the analyzed web site. The health indicators and single display are informational displays that can compare and provide an indication or score of the website's health. This may be graphical (such as a stop sign or pressure signal) or alpha-numerical (such as a letter or number rating) but should provide an indication on the website's comparison internally and/or externally to related websites, predicted performance and past performance, industry trends, seasonality, volatility, day-of-the-week, adjacent industry trends, and expected results from the size and scope of the analyzed internet site.

The health indicator, as an aggregate of multiple relevant metrics, allows a user to see in a single view the state of the website and provide alerts and insight to the necessary actions to bring the Internet site to an effective performance level or maintain a healthy internet site state.

In step 106, the health indicator and related metrics are formatted and delivered to various systems, permitting a single view into the health of the website and permitting a breakdown of the factors comprising the indicator. This makes the metric and indicator accessible over an API. Providing the breakdown and overall health indicator also permits a recombination of metrics to arrive at new indicators based on the intended audience. For example, a marketing executive 22 may be concerned more with certain metrics than an administrator 18. The metrics can be combined in a different way to present a graphic representation for the marketing executive and a separate and different score for the administrator.

Delivery of this health indicator may be in the form of an alarm 20 or warning system delivered to one or more administrators when the health of their website starts to decline. Metric parameters 24 for the alarm can be set manually or automated to provide an alert when the metric declines below or exceeds a set threshold. The alert parameter can set to respond to a single metric or only to a specified combination of metrics, such as only providing an alert if the number of visitors is below a certain point and the bounce rate changes. The system can also use the website's past performance to gauge typical standard deviations and automatically account for this in the alarm. For example, the alarm will only sound if a metric falls outside of one or two standard deviations as calculated from historical evidence and taking into account other identifiable factors which alter operating parameters such as day-of-the-week and seasonality.

The alarm can also use parameters based on competitors' typical standard deviations and an aggregated expected performance range similar to benchmarking. For example, if competitors and similar websites have a conversion rate range of 0.25% plus or minus 0.02%, the system can establish this as an acceptable range for a normal operating parameter, and alerts will only be sent out when the user's website's conversion rate falls outside this range. If these parameters are set manually by the user, then the user can specify any range they want as an acceptable operating parameter and notification will only be sent when their website's metrics falls outside this range. The system may offer numerous methods for notifying users of when the operating parameters are outside of specified values. These methods may include the following: email, text, phone, newsfeeds, embedded modules or any other network enabled delivery mechanism. The messages may be composed of texts, graphics, voice, pdf, html, portable document format or any other digital delivery format. Users can optionally select a preferred method of notification.

The alarm system may also provide information about which metric triggered the alert and offer guidance to the user as to the significance of that metric, common problems associated with that metric, common solutions to improving that metric, as well a detailed troubleshooting guide that assists the user in determining what triggered the metric to fall outside the operating parameter. Additionally, the notification will include a method to contact the appropriate person if they need assistance in identifying, evaluating, and/or fixing the problem that has caused the metric to be outside the determined operating parameter. A method of contacting assistance may include a telephone number, form, live chat, email address, or any other means of communication.

The health metric may be presented through a variety of delivery mechanisms, including an integrated dash board, embedded widgets (components that can be placed in external dashboards, websites, and desktop applications) that communicate directly with the analytics system, plug-in interfaces that embed in third party system such as existing eCommerce internet sites and blogs that communicate with the analytics system and deliver a customized user experience, and third party applications using a programming API (application programming interface) communicating with the analytics system to add the health metrics features to the third party application. An integrated system dashboard allows viewing of individual aspects of the statistical data that make up the health metric. Other features of the dashboard can be used to set data sources, pursue solutions when the system indicates a problem, input manual data which cannot be imported automatically, and manage account and profile information.

A detailed break out of the metrics, where the user can see the specific data comprising the metrics and how the metrics determine the health indicator, permits the viewer to assess where the specific areas are that the Internet site is below an acceptable health level or are within acceptable parameters, as described above. Seeing all the component parts of the health indicator permits a user to evaluate a website more clearly by providing specific guidance when one or more of the individual metrics are outside the acceptable parameters. The system can permit a viewer to see groups of metrics or a single metric that are outside of specified parameters, such as Page Loads, Unique Visits, First Time Visits, Returning Visits, Conversion Rate, Average Order Size, Checkout Conversion Rate, Bounce Rate, Page Views, Social Sharing, Keyword Reference, Backlinks, and Advertising Click Through. The display can include a real-time update of the metrics and their level of operation as new data is gathered by the system.

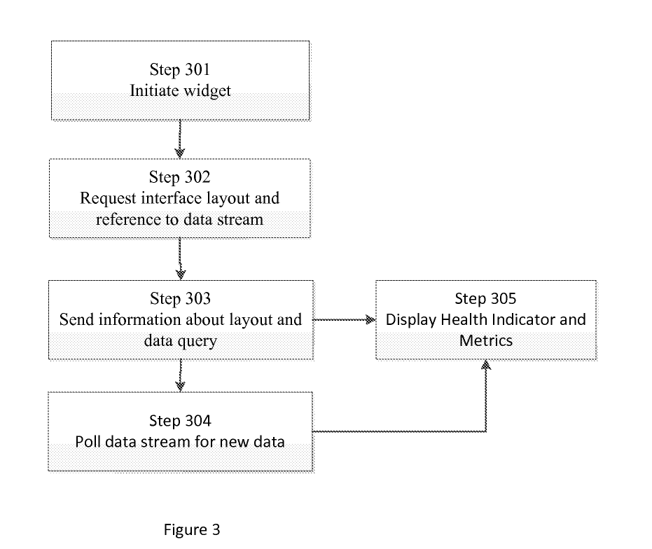

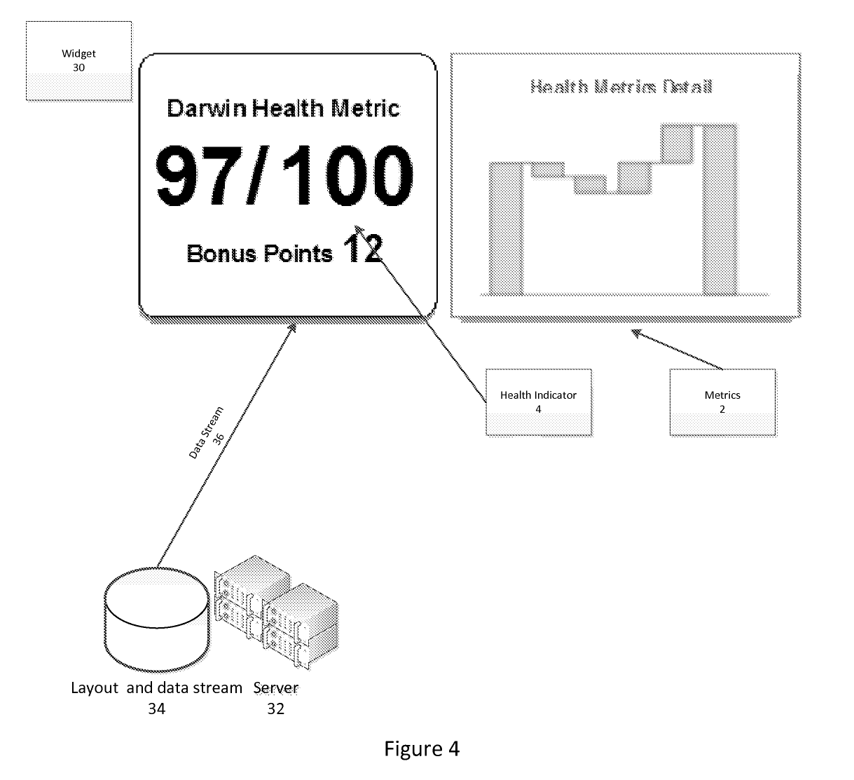

As shown in FIG. 3 and FIG. 4, the system can include widgets 30 through web-services, javascript, or other Internet delivery methods to embed a display that shows a continually updating health indicator in executive dashboards, ecommerce shopping carts systems, reporting systems or any other data monitoring systems. Pre-configured widgets may also be generated form a network enabled server and inject the interface and data directly into the host dashboard or host application. Widgets contain configuration parameters that identify the account reference, data identifiers, authentication parameters, and any additional ancillary configuration parameters needed for user interface configuration, data selection, and security settings.

When a server delivered widget is initiated in step 301, the widget requests the web-service server 32 to provide an interface layout and a reference to the data stream 36 necessary for the proper display of information 34 and any security authentication or security certificates that is required. When integrated system modules are initiated from the host system, they make a request to the server for the layout, authentication tokens, and data stream. Widgets and modules make the request to the web-services and authenticate when necessary, acquiring a token or certificate and encrypting the data transfer over secure channels when requested.

In step 303, the widget or module sends information that identifies the layout settings and a data query to the web-services that will return necessary data, graphics or code to properly display the requested information and will use this data to configure or produce the requested interface to the data. Data query information delivered to the web-services will return a reference to the data stream or feed for the requested data. In step 304, the widget either polls the data stream at regular intervals or opens a connection to the web-services server that the server uses to push data when new information is available (depending on widget or module configuration). In step 305, the widgets can display the overall health indicator, individual metrics, comparisons to past performance and predicted performance, related and adjacent industries, and details of the change in metrics. The widget can automatically include additional metrics as necessary when additional data points become available.

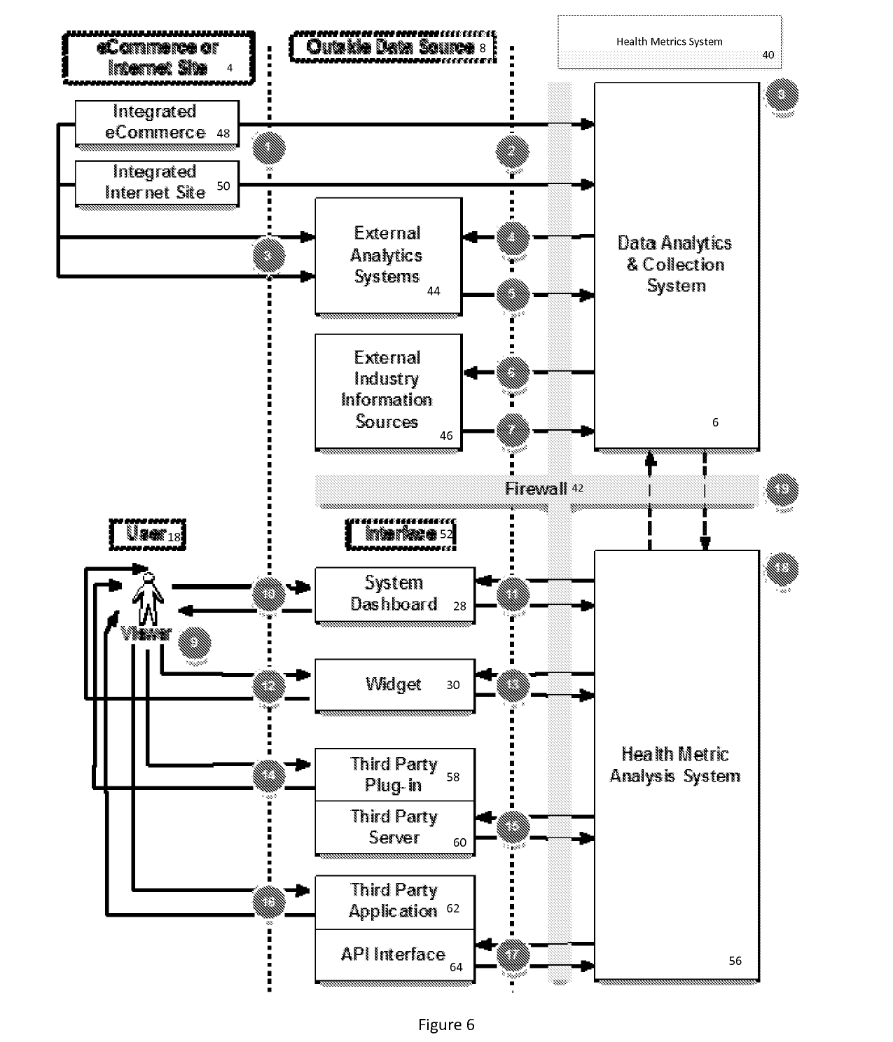

As shown in FIG. 6, the system can be implemented as a server based web service that consists of a dashboard 28 that can be used to add data sources for analysis, including user inputted sources such as accounting information and generated data such as ecommerce buying trends, website ranking information, social metrics, and data containing third party information such as POS systems, industry and site specific trends, and comparative data. A data collecting service can run at regular intervals coupled with real-time data services to provide real-time health metrics to the viewer. Internet site analytics services can be provided directly through the system for those who do not wish to use third party analytics or wish to have additional reference data points to validate against.

The following is an example of how the health indicator is generated. Other factors that can be included in the math are seasonality, predicted numbers for each evaluated metric, and numerous other independent and dependent variables that serve the purpose of aggregating multiple data points into a singular score. The following example utilizes multiple regressions to calculate a health indicator based on several key variables, but other forms of math including neural networking would yield similar results and may be preferable.

In this example, the health metric system is evaluated as follows: Website Health=100*CR_{H}*AOS_{H}*CCR_{H}*BR_{H}*PV_{H}*T_{H}, rounded to nearest integer.

Conversion Rate Health (CR_{H}) is the rate at which an Internet user of an ecommerce or Internet service system becomes a member or engages in some form of interaction where they share information with the ecommerce or Internet service. Conversion Rate is significant in that a goal of ecommerce or Internet services is to persuade visitors to a site or service to participate or become a member of the service, which may lead to a purchase conversion.

If CR_{Z}>=0, then CR_{H}=1+CR_{Z}̂SDE_{P}*(CR_{W}*LE_{P}/2500).

If CR_{Z}<0, then CR_{H}=1−ABS(CR_{Z})̂SDE_{N}*(CR_{W}*LE_{N}/2500).

If CR_{H}<0.5, then CR_{H}=0.5, otherwise CR_{H}=CR_{H}.

CR_{Z} is today's z-score for conversion rate.

CR_{Z}=(Today's CR−30 Day average for CR)/CR Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

CR_{W} is the conversion rate weight parameter.

ABS(x) is the absolute value of x.

Average Order Size (AOSH) is the average purchase amount of an ecommerce product or service. Average order size indicates how well products and/or services are presented on an ecommerce or Internet services website, how effectively priced the products or services are, or how well the ecommerce or Internet services website upsells additional products.

If AOS_{Z}>=0, then AOS_{H}=1+AOS_{Z}̂SDE_{P}*(AOS_{W}*LE_{P}/2500).

If AOS_{Z}<0, then AOS_{H}=1−ABS(AOS_{Z})̂SDE_{N}*(AOS_{W}*LE_{N}/2500).

If AOS_{H}<0.5, then AOS_{H}=0.5, otherwise AOS_{H}=AOS_{H}.

AOS_{Z} is today's z-score for average order size.

AOS_{Z}=(Today's AOS−30 Day average for AOS)/AOS Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

AOS_{W} is the average order size weight parameter ABS(x) is the absolute value of x.

Checkout Conversion Rate Health (CCR_{H}) is average rate at which a participator of an ecommerce or Internet service will make a purchase or engage in services. The Checkout Conversion Rate is significant in that the main goal of an ecommerce or Internet services site is to persuade participators to make a purchase from or engage in the services provide by the ecommerce or Internet site.

If CCR_{Z}>=0, then CCR_{H}=1+CCR_{Z}̂SDE_{P}*(CCR_{W}*LE_{P}/2500).

If CCR_{Z}<0, then CCR_{H}=1−ABS(CCR_{Z})̂SDE_{N}*(CCR_{W}*LE_{N}/2500).

If CCR_{H}<0.5, then CCR_{H}=0.5, otherwise CCR_{H}=CCR_{H}.

CCR_{Z} is today's z-score for checkout conversion rate.

CCR_{Z}=(Today's CCR−30 Day average for CCR)/CCR Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

CCR_{W} is the checkout conversion rate weight parameter.

ABS(x) is the absolute value of x.

Bounce Rate Health (CR_{H}) is the rate at which a visitor only views a single page on a website, that is, the visitor leaves a site without visiting any other pages before a specified session-timeout occurs. Bounce rates indicates the effectiveness or performance of an entry page. An entry page with a low bounce rate means that the page effectively causes visitors to view more pages and continue on deeper into the web site.

If BR_{Z}>=0, then BR_{H}=1+BR_{Z}̂SDE_{P}*(BR_{W}*LE_{P}/2500).

If BR_{Z}<0, then BR_{H}=1−ABS(BR_{Z})̂SDE_{N}*(BR_{W}*LE_{N}/2500).

If BR_{H}<0.5, then BR_{H}=0.5, otherwise BR_{H}=BR_{H}.

BR_{Z} is today's z-score for bounce rate.

BR_{Z}=(Today's BR−30 Day average for BR)/BR Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

BR_{W} is the bounce rate weight parameter.

Page View Health (PV_{H}) is a request to load a single HTML file of an Internet site. This information is significant in that any change in the ‘page’ (such as the information or the way it is presented) can results in rise or drop in visits to the page and exposure to any advertisements or campaign efforts.

If PV_{Z}>=0, then PV_{H}=1+PV_{Z}̂SDE_{P}*(PV_{W}*LE_{P}/2500).

If PV_{Z}<0, then PV_{H}=1−ABS(PV_{Z})̂SDE_{N}*(PV_{W}*LE_{N}/2500).

If PV_{H}<0.5, then PV_{H}=0.5, otherwise PV_{H}=PV_{H}.

PV_{Z} is today's z-score for page views.

PV_{Z}=(Today's PV−30 Day average for PV)/PV Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

PV_{W} is the page view weight parameter.

ABS(x) is the absolute value of x.

Traffic Health (TH) is measured to see the popularity of web sites and individual pages or sections within an Internet site. This is significant in that all key indicators originate from the web traffic to an Internet Website and shows the state of Search Engine Optimization, advertising, and organic Internet popularity.

T_{H}=PL_{H}*UV_{H}*FTV_{H}*RV_{H}.

If T_{H}<0.5, then T_{H}=0.5, otherwise T_{H}=T_{H} where . . . Page Load Health PL_{H}.

If PL_{Z}>=0, then PL_{H}=1+PL_{Z}̂SDE_{P}*(T_{W}*LE_{P}/2500)*PL_{CW}/(PL_{CW}+UV_{CW}+FTV_{CW}+RV_{CW}).

If PL_{Z}<0, then PL_{H}=1−ABS(PL_{X})̂SDE_{N}*(T_{W}*LE_{N}/2500)*PL_{CW}/(PL_{VW}+UV_{CW}+FTV_{CW}+RV_{CW}).

Unique Visits Health UV_{H} is if UV_{Z}>=0, then UV_{H}=1+UV_{Z}̂SDE_{P}*(T_{W}*LE_{P}/2500)*UV_{CW}/(PL_{CW}+UV_{CW}+FTV_{CW}+RV_{CW}).

If UV_{Z}<0, then UV_{H}=1−ABS(UV_{Z})̂SDE_{N}*(T_{W}*LE_{N}/2500)*UV_{CW}/(PL_{CW}+UV_{CW}+FTV_{CW}+RV_{CW}).

First Time Visits Health FTV_{H} is If FTV_{Z}>=0, then FTV_{H}=1+FTV_{Z}̂SDE_{P}*(T_{W}*LE_{P}/2500)*FTV_{CW}/(PL_{CW}+UV_{CW}+FTV_{CW}+RV_{CW}).

If FTV_{Z}<0, then FTV_{H}=1−ABS(FTV_{Z})̂SDE_{N}*(T_{W}*LE_{N}/2500)*FTV_{CW}/(PL_{CW}+UV_{CW}+FTV_{CW}+RV_{CW}).

Returning Visits Health RV_{H} is If RV_{Z}>=0, then RV_{H}=1+RV_{Z}̂SDE_{P}*(T_{W}*LE_{P}/2500)*RV_{CW}/(PL_{CW}+UV_{CW}+FTV_{CW}+RV_{CW}).

If RV_{Z}<0, then RV_{H}=1−ABS(RV_{Z})̂SDE_{N}*(T_{W}*LE_{N}/2500)*RV_{CW}/(PL_{CW}+UV_{CW}+FTV_{CW}+RV_{CW}).

PL_{Z} is today's z-score for page loads.

UV_{Z} is today's z-score for unique visits.

FTV_{Z} is today's z-score for first time visits.

RV_{Z} is today's z-score for returning visits.

PL_{Z}=(Today's PL−30 Day average for PL)/PL Standard Deviation.

UV_{Z}=(Today's UV−30 Day average for UV)/UV Standard Deviation.

FTV_{Z}=(Today's FTV−30 Day average for FTV)/FTV Standard Deviation.

RV_{Z}=(Today's RV−30 Day average for RV)/RV Standard Deviation.

SDE_{P} is the Standard Deviation Exaggeration parameter for positive z-score metrics.

SDE_{N} is the Standard Deviation Exaggeration parameter for negative z-score metrics.

LE_{P} is the Linear Exaggeration parameter for positive z-score metrics.

LE_{N} is the Linear Exaggeration parameter for negative z-score metrics.

T_{W} is the traffic weight parameter.

PL_{CW} is the page loads category weight parameter.

UV_{CW} is the unique visits category weight parameter.

FTV_{CW} is the first time visits category weight parameter.

RV_{CW} is the returning visits category weight parameter.

An example of a system implementing the health indicator is show in FIG. 6. In step 1, Internet sites report user behavior to a health metric analytics system 40 directly.

In step 2, data is received by the analytics system securely through a firewalled interface 42. In step 3, Internet sites report user behavior to external analytics systems 44.

In step 4, the health metrics analytics system requests data from third party analytics systems. In step 5, the health metrics analytics system collects statistical data from external analytics systems for processing.

In step 6, the health metric analytics system requests industry data and trend information from external statistical data sources 46. In step 7, data is received from external industry data sources for analysis.

In step 8, collected data is processed, normalized, and prepared for analysis. In step 9, the health metric is displayed to a user. In step 10, a user logs into the integrated analytics system dashboard and views health metric information or receives electronic reports through various deliver mechanisms (such as email and/or push to personal electronic device).

In step 11, a dashboard requests health metric data through a secure firewall interface 42. In step 12, a user views an embedded health metric widget which displays a graphical form of the health indicator. In step 13, the widget requests and receives updated metric data and updated visual layout settings over a secure firewalled interface.

In step 14, user interfaces to third party system 58 implementing a health metrics plug-in Internet server module. In step 15, the third party plug-in Internet server module requests health metric information from the health metric analytics system or a secure firewalled interface. In step 16, a user interfaces with a third party application 62 to view health metric information. In step 17, the third party application uses the health metric API 64 to request health metric data over a secure firewalled interface.

In step 18, the health metric analysis system calculates the health metric data from the collected data from the data analytics and collection system and produces health metric results delivered to the various user interface displays.

In step 19, a secure firewall will secure communication between various aspects of the system; collected data and identifiable information will be secured from all user interfaces and also secured from the analytics system that produces the heath metrics data.

What is claimed is:

1. A method for evaluating the health of a website comprising:
a. Aggregating data about the website,
b. Applying an algorithm to the aggregated metric data to determine a health indicator, and
c. Displaying a visual representation of the health indicator.

2. A method according to claim 1, where the metric data comprises data obtained from sources other than the entity providing the health indicator.

3. A method according to claim 1, further comprising normalizing the data before applying an algorithm to the metric data to determine a health indicator.

4. A method according to claim 1, where the visual representation comprises a graphic that shows the current health of the website.

5. A method according to claim 1, where the visual representation comprises a numeric value that represents the current health of the website.

6. A method according to claim 1, where the visual representation is displayed through a widget.

7. A method according to claim 1, where a visual representation of the metric data is displayed when a user interacts with the health indicator.

8. A method according to claim 1, where the health indicator can vary depending on the viewed of the health indicator.

9. A method of alerting a user to a change in the health of a website comprising:
a. Aggregating data about the website,
b. Calculating operating parameters based on the aggregated data.
c. Obtaining updates to the aggregated data, and
d. Providing an alert if the updated data is outside the operating parameters.

10. A method according to claim 9, where the aggregated data comprises data on the website's past performance.

11. A method according to claim 9, where the operating parameters comprise performance expectations based on websites similar to the website.

12. A method according to claim 9, where the display of the alert depends on the type of data that is outside the operating parameters.

13. A method according to claim 9, where delivery of the alert varies based on the data that is outside the operating parameters.

14. A method according to claim 9, where the alert comprises common causes for the data falling outside of the operating parameters.

15. A system for determining the health of a website comprising:
a. At least one data source that provides metrics,
b. A server that processes an algorithm to determine a health indicator based on the metrics provided from the at least one data sources, and
c. A visual display of the health indicator.

16. A system according to claim 15, where the at least one data source comprises a plurality of data sources.

17. A system according to claim 15, further comprising a dashboard.

18. A system according to claim 15, further comprising a widget.

19. A system according to claim 15, where the visual display comprises a dynamic layout that depends on the metrics used by the algorithm to calculate the health indicator.

20. A system according to claim 15, further comprising a visual display of the metric data.
